(19) United States
(12) Patent Application Publication
(10) Pub. No.: US 2019/0264608 A1
(43) Pub. Date: Aug. 29, 2019

(54) GEAR TRAIN FOR OPPOSED-PISTON ENGINES

(71) Applicant: Achates Power, INC., San Diego, CA (US)

(72) Inventors: SUMANTH KASHYAP, San Diego, CA (US); John M. Kessler, San Diego, CA (US); Paul Meckl, San Diego, CA (US); Fabien G. Redon, San Diego, CA (US); Sebastian Strauss, Vista, CA (US)

(73) Assignee: Achates Power, INC., San Diego, CA (US)

(21) Appl. No.: 16/382,022

(22) Filed: Apr. 11, 2019

Related U.S. Application Data
(63) Continuation of application No. PCT/US2017/057017, filed on Oct. 17, 2017.

(51) Int. Cl. F02B 75/28; F02B 67/04; F16H 1/22

(52) U.S. Cl. CPC F02B 75/282; F16H 1/22; F02B 67/04

(57) ABSTRACT

A gear train connecting two crankshafts in an opposed-piston engine includes a first crankshaft coupled to first pistons and a second crankshaft coupled to second pistons which are disposed in opposition to the first pistons in cylinders of the engine, a respective crank gear attached to each crankshaft, and an idler gear connecting the crank gears. The gear train comprises a three-gear system that is configured to minimize the side loads on the crankshafts, as well as on an idler gear post.

### RELATED APPLICATIONS

This application is a continuation of international application no. PCT/US2017/057017, filed on Oct. 17, 2017, which in turn claims priority to U.S. Provisional Application No. 62/411,820, filed on Oct. 24, 2016, titled “Gear Train For Opposed-Piston Engines.” This application contains subject matter related to the subject matter of U.S. application Ser. No. 13/385,539, filed Feb. 23, 2012, titled “Dual Crankshaft; Opposed-Piston Engine Constructions,” now U.S. Pat. No. 10,060,345 issued Aug. 28, 2018.

### STATEMENT REGARDING FEDERALLY SPONSORED RESEARCH

This invention was made with government support under Award No.: DE-AR0000657 awarded by the Advanced Research Projects Agency-Energy (ARPA-E). The government has certain rights in the invention.

### FIELD

The field of the invention relates to gear trains to connect crankshafts in opposed-piston, internal combustion engines with reduced friction when compared to conventional gear systems. More specifically, the invention relates to gear trains that use a three-gear system to connect the crankshafts, and may include those which take power directly off of the exhaust crankshaft.

### BACKGROUND

When compared to conventional “Vee” and straight-inline internal combustion engines with a single piston in each cylinder, opposed-piston engines possess fundamental architectural advantages in thermodynamics and combustion that deliver improvements in measures of engine performance. In some opposed-piston engines, the motion of the pistons determines the opening and closing of intake and exhaust ports during a combustion cycle. In order to maintain the desired timing between port openings and closings, a connection is needed between the opposed-pistons, whether that connection be a timing belt or a gear train.

Some current opposed-piston engines use a gear train to control the timing of port openings and closings, for example to maintain a crank lead on the exhaust side of the piston motion. In many instances, such gear trains may have five or more gears in the train. Each gear-to-gear interaction, or mesh, in a gear train has an amount of friction associated with it. Additionally, each mesh contributes to compliance in the gear system which can contribute to increased lash in each mesh, which in turn increases engine noise and correlates to loss in torque or power transmission along the gear train.

Changes in gear system configuration in opposed-piston engines can lead to benefits that include reduced friction, increased system stiffness, and better transmission of torque through the gear system.

### SUMMARY

A gear train for use in an opposed-piston engine that includes a first gear connected to a first crankshaft, a second gear connected to a second crankshaft, and an idler gear positioned between the first and second gears as provided in some implementations described herein. In the gear train, the idler gear is configured to transmit torque from the first gear to the second gear through a first gear mesh and a second gear mesh. A center of the first gear is aligned with a longitudinal cylinder axis of the opposed-piston engine, and a center of the second gear is also aligned with the longitudinal cylinder axis of the opposed-piston engine, while the idler gear is not aligned with the longitudinal cylinder axis of the opposed-piston engine. An angle α between the longitudinal cylinder axis and a line of action that passes through the first gear mesh is greater than or equal to 0° and less than 90°. In some implementations, the gear train consists essentially of a first gear connected to a first crankshaft, a second gear connected to a second crankshaft, and an idler gear positioned between the first and second gears, and no other gears are present in the gear system.

The following features may be combined in any suitable way in the gear train described herein. The first crankshaft can be an intake crankshaft, wherein the intake crankshaft is connected to one or more intake pistons in the opposed-piston engine whose motion opens and closes one or more intake ports, and the second crankshaft can be an exhaust crankshaft, wherein the exhaust crankshaft is connected to one or more exhaust pistons in the opposed-piston engine whose motion opens and closes one or more exhaust ports. In some such implementations, a transmission to provide driving power may be operably connected to either the second gear or second crankshaft. Further, in some gear trains, auxiliary systems may be operably connected to the first crankshaft, and the auxiliary systems can be configured to take power from the first crankshaft. The auxiliary systems may include devices such as a compressor, a supercharger, a pump, or any combination thereof. The gear train may be configured to maintain a timing of relative motion between the intake and exhaust pistons in the opposed-piston engine.

In further related instances, a dual-crankshaft, opposed-piston engine includes at least one cylinder, each cylinder having longitudinally-separated exhaust and intake ports and a pair of pistons disposed in opposition to one another in a cylinder bore, the pair of pistons including an intake piston configured to move in the cylinder bore across an intake port and an exhaust piston configured to move in the cylinder bore across an exhaust port; an intake crankshaft; an exhaust crankshaft; and a three-gear system connecting the intake crankshaft and the exhaust crankshaft. The intake crankshaft is operably connected to the intake piston of each cylinder, and the exhaust crankshaft is operably connected to the exhaust piston of each cylinder. The three gear system includes a first gear connected to the intake crankshaft; a second gear connected to the exhaust crankshaft; and an idler gear positioned between the first and second gears, wherein the idler gear is configured to transmit torque from the first gear to the second gear through a first gear mesh and a second gear mesh. In the opposed-piston engine, a center of the first gear is aligned with a longitudinal cylinder axis of the opposed-piston engine; a center of the second gear is aligned with the longitudinal cylinder axis of the opposed-piston engine; and the idler gear is not aligned with the longitudinal cylinder axis of the opposed-piston engine. Also in the opposed-piston internal combustion engine, an angle α between the longitudinal cylinder axis and a line of action that passes through the first gear mesh is greater than or equal to 0° and less than 90°.

The following features may be combined in any suitable way in an opposed-piston engine with first and second crankshafts. The first crankshaft may be an intake crankshaft, and the intake crankshaft may be connected to one or more intake pistons in the opposed-piston engine such that the intake crankshaft's motion opens and closes one or more intake ports. The second crankshaft may be an exhaust crankshaft, with the exhaust crankshaft connected to one or more exhaust pistons in the opposed-piston engine such that the exhaust crankshaft's motion opens and closes one or more exhaust ports. In some aspects, a transmission to provide driving power may be operably connected to either the second gear or second crankshaft. Further, in some further aspects, auxiliary systems of the engine are operably connected to the first crankshaft, and the auxiliary systems may be configured to take power from the first crankshaft. The auxiliary systems may include devices such as a compressor, a supercharger, a pump, or any combination thereof. The gear train may be configured to maintain a timing of relative motion between intake and exhaust pistons in the opposed-piston engine.

In further instances, a gear train for use in an opposed-piston engine includes a first crankshaft gear, a second crankshaft gear, a first idler gear, a second idler gear, and a drive transmission. The first crankshaft gear is connected to a first crankshaft, and the second crankshaft gear is connected to a second crankshaft. The first idler gear is positioned between the first crankshaft gear and the second idler gear, and the first idler gear is configured to transmit torque from the first crankshaft gear to the second idler gear through a first gear mesh and a second gear mesh. The drive transmission is operably connected to either the first crankshaft or the second crankshaft. In such gear trains, a center of the first crankshaft gear is aligned with a longitudinal cylinder axis of the opposed-piston engine; a center of the second crankshaft gear is aligned with the longitudinal cylinder axis of the opposed-piston engine. Further, in the gear train, the first and second idler gears are not aligned with the longitudinal cylinder axis of the opposed-piston engine, the first gear mesh is between the first crankshaft gear and the first idler gear, the second gear mesh is between the first idler gear and the second idler gear, and an angle α between the longitudinal cylinder axis and a line of action that passes through the second gear mesh is greater than or equal to 0° and less than 90°.

### BRIEF DESCRIPTION OF THE DRAWINGS

FIGS. 1-3 are views of a known arrangement of cylinders, pistons, and a gear train in an opposed-piston engine, and are properly labeled “Prior Art”.

FIG. 4 is a view of a unique 3-gear train for use with an opposed-piston combustion engine.

FIGS. 5A and 5B are perspective views from opposite viewpoints of a unique 3-gear system in an opposed-piston engine that incorporates the gear train of FIG. 4.

FIGS. 6A and 6B are schematic diagrams showing force relationships of the 3-gear system according to FIGS. 4 and 5 when installed in an opposed-piston combustion engine.

FIG. 7A is a schematic diagram showing a first gear layout embodiment for the 3-gear system of FIGS. 4 and 5.

FIG. 7B is a schematic diagram showing a second gear layout embodiment for the 3-gear system of FIGS. 4 and 5.

FIG. 8 is a view of a gear layout for a 4-gear system in an opposed-piston internal combustion engine.

### DETAILED DESCRIPTION OF THE PREFERRED EMBODIMENTS

A gear train for an opposed-piston engine that can be used to transmit torque, as well as to maintain timing between piston movements, is described below. Methods for using such gear trains and engines that have such gear trains are also described, as are techniques for designing and making gear trains for an opposed-piston engine.

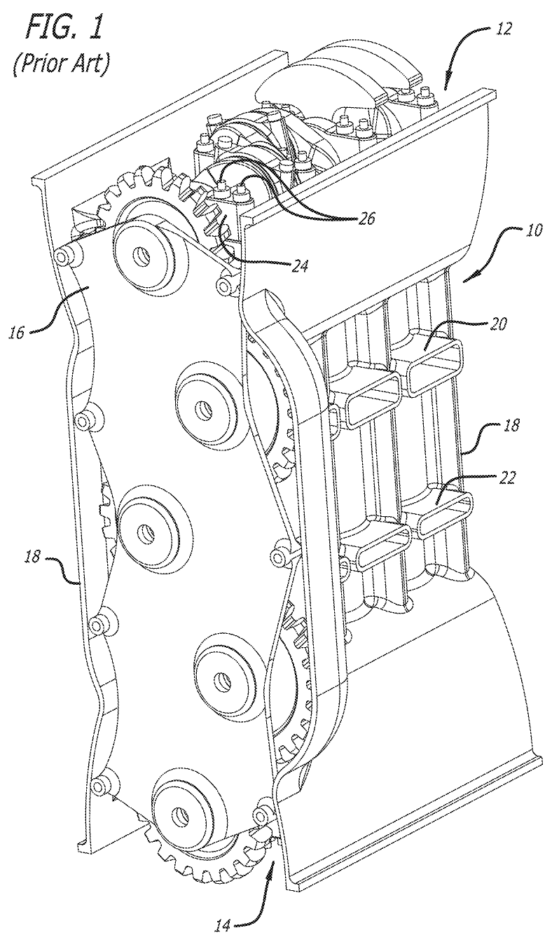

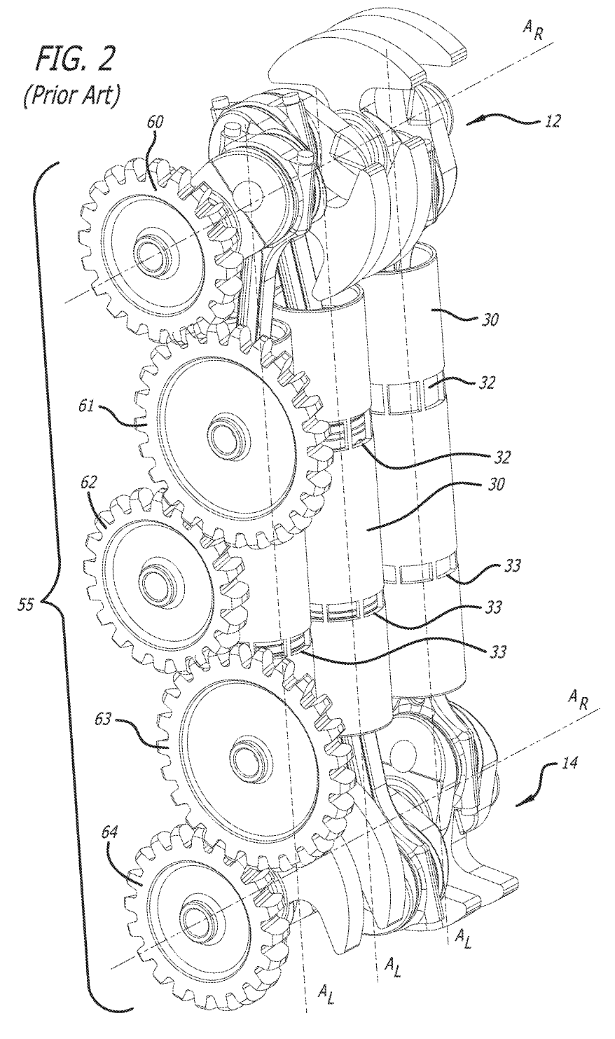

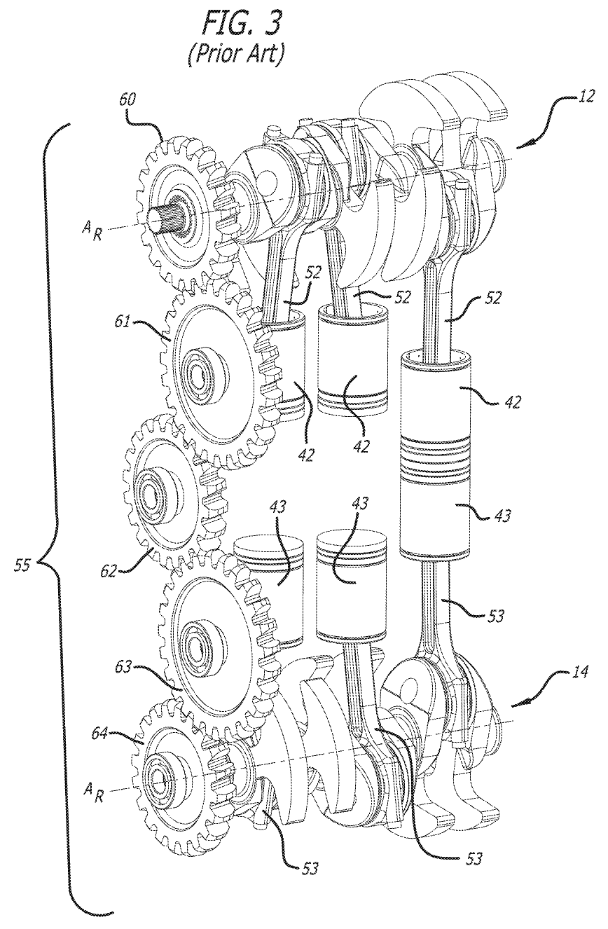

FIG. 1 illustrates a known arrangement comprising a partially constructed dual-crankshaft, opposed-piston, internal combustion engine 10 with two crankshafts designated as a first crankshaft 12 and a second crankshaft 14. An end panel 16 supports a gear train that connects the crankshafts. Side panels 18 include exhaust and intake channels 20 and 22 that communicate with exhaust and intake ports of one or more cylinders. Main bearing caps 24 and bolts 26 secure the crankshafts in place. Referring to FIGS. 2 and 3, the engine includes one or more ported cylinders 30. For example, the engine can include one, two, three, or more cylinders. Each cylinder 30 has a longitudinal axis A_{L} and exhaust and intake ports 32 and 33. The cylinders 30 are juxtaposed and oriented with exhaust and intake ports mutually aligned. The crankshafts 12 and 14 are disposed in a spaced-apart relationship, with parallel axes of rotation A_{R}. In the example shown, the crankshafts are rotatably mounted at respective exhaust and intake ends of the cylinders 30. In such instances, which are not meant to be limiting, the crankshafts may be respectively indicated as the exhaust crankshaft 12 and the intake crankshaft 14. The cylinders 30 are disposed in an inline array, in which their longitudinal axes A_{L} are parallel and generally contained in a plane that intersects the cylinders 30 and contains the parallel axes A_{R} of the crankshafts 12 and 14. A pair of pistons 42, 43 is disposed for opposed sliding movement of the pistons in the bore of each cylinder 30. All of the pistons 42 controlling the exhaust ports 32 are coupled by connecting rods 52 to respective cranks of the exhaust crankshaft 12; all of the pistons 43 controlling the intake ports 33 are coupled by connecting rods 53 to respective cranks of the intake crankshaft 14. The crankshafts 12 and 14 are connected by a prior art gear system 55 that includes the gears 60-64. In some aspects, each of the cranks on the exhaust crankshaft 12 can lead a corresponding crank of the intake crankshaft 14 by a predetermined angle Ø; this predetermined amount of difference is known as crank lead. Preferably, although not necessarily, driving power is taken from the exhaust crankshaft 12, while the intake crankshaft 14 is coupled to run auxiliary devices such as pumps, a supercharger, and a compressor.

The gear system 55 that connects crankshafts 12 and 14 in FIGS. 2 and 3 not only maintains the amount that the exhaust crankshaft 12 leads the intake crankshaft (e.g., maintains the crank lead), but it transmits energy from one crankshaft to the other. In the case where driving power is taken from the exhaust crankshaft 12, any power not used to run auxiliary devices on the intake crankshaft 14 is transmitted through the gear system 55 to the exhaust crankshaft 12. Because force, torque, or motion is changed/transmitted, through the gear system 55 from one crankshaft to the other, the gear system 55 can also be termed a “gear train”.

There are five gears 60-64 in the gear train 55 shown in FIGS. 2 and 3. The gear train 55 has four gear-to-gear meshes, or interaction points, each of which contributes to the compliance of the gear train, as well as the noise generated by the gear train. Deviation in the crankshafts from the predetermined crank lead set point is known as compliance in the gear system. Compliance and noise correlate to losses in transmission of torque through the gear train.

Preferred Embodiments of a Gear Train with Reduced Friction, Increased Stiffness, and Improved Transmission of Torque:

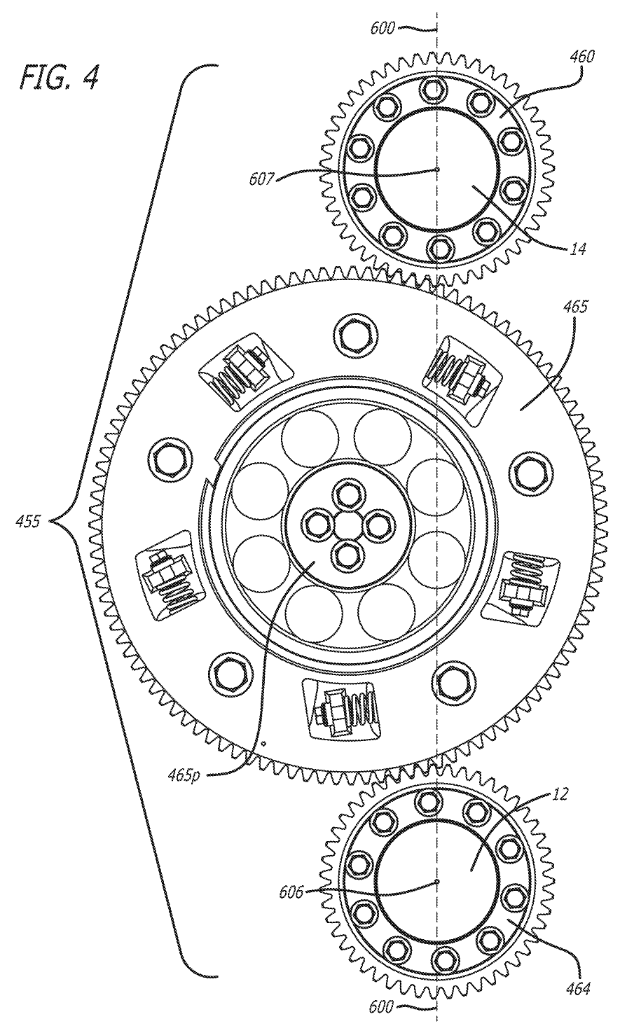

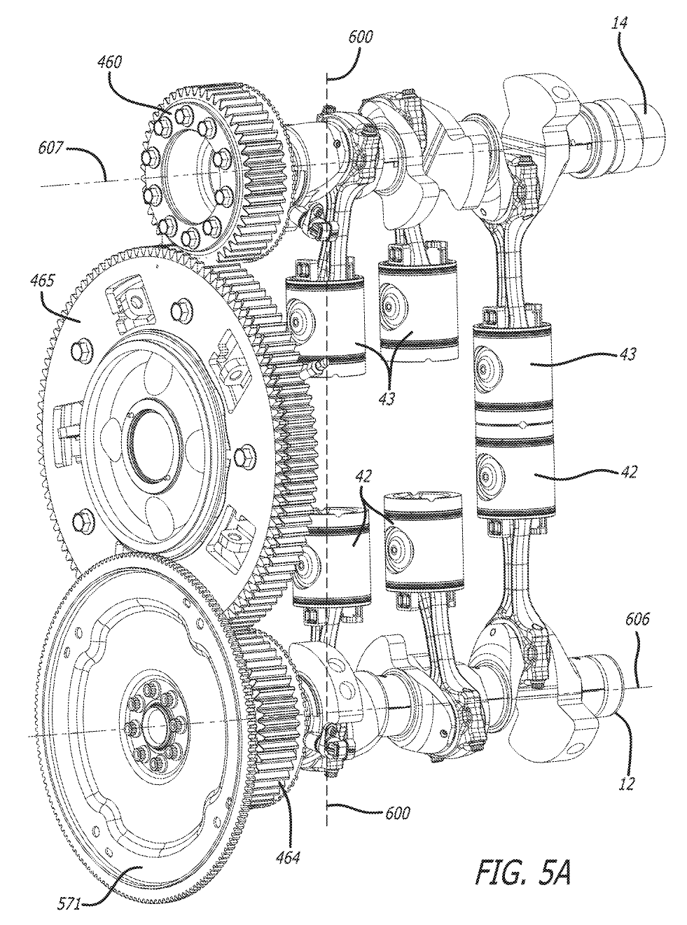

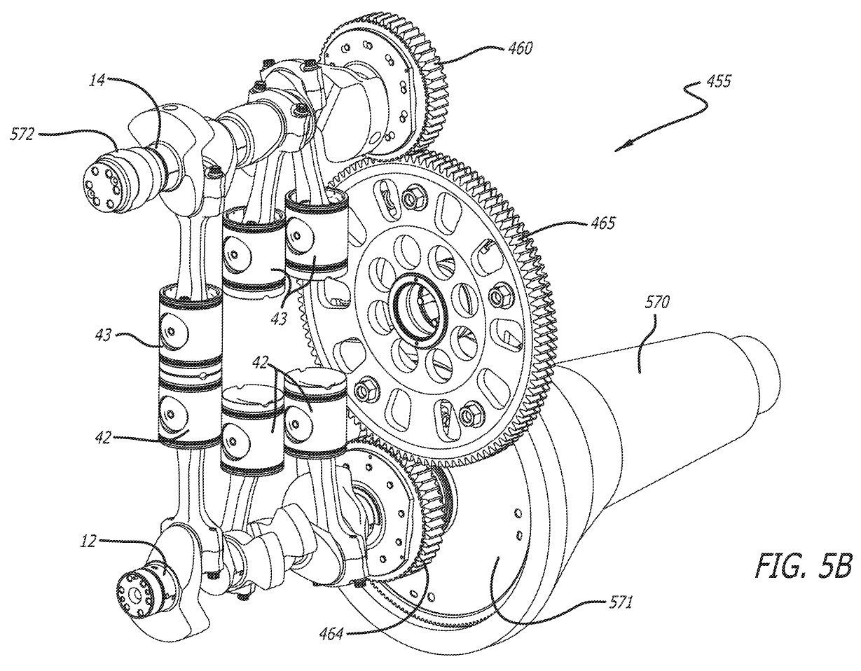

FIG. 4 illustrates a unique gear train 455 which reduces friction, increases stiffness, and improves transmission of torque as compared with the gear train 55. FIGS. 5A and 5B illustrate how an opposed piston engine may be equipped with the gear train 455.

With reference to FIG. 4, unlike the gear train 55, the gear train 455 has three gears: a first gear 460, a second gear 464, and an idler gear 465 that is contiguous with and connects the two gears 460 and 464. Thus, this gear train has only two gear meshes, as opposed to four meshes of the prior art gear train 55 shown in FIGS. 2 and 3, and so will be stiffer, potentially less noisy, and in turn able to transmit torque more efficiently. In the views shown in FIGS. 5A and 5B the opposed piston engine has same exhaust and intake arrangements as the engine of FIGS. 1-3. These arrangements are, however, inverted from those shown in FIGS. 1-3. In this regard, the crankshafts 12 and 14 are disposed in a spaced-apart, parallel relationship that is substantially vertical and in which the exhaust crankshaft 12 and pistons 42 are disposed below the intake crankshaft 14 and pistons 43. This vertical arrangement is convenient for engine fitment in wheeled vehicles in which drive trains are located beneath drivers and occupants (as illustrated in commonly-owned US 2014/0332306 A1, now U.S. Pat. No. 9,849,770), but it is not meant to limit the principles disclosed herein. As per FIGS. 5A and 5B, the first gear 460 is attached to the crankshaft 14, the second gear 464 is attached to the crankshaft 12, and the idler gear 465 is mounted therebetween for rotation on a post (not shown).

With reference to FIGS. 5A and 5B, in an arrangement for coupling dual-crankshaft, opposed-piston engine to the drive train of a motor vehicle, the gear train 455 is arranged to connect the crankshafts 12 and 14, and, a drive transmission 570 is coupled to a crankshaft by a flex plate 571. Preferably, the flex plate 571 is bolted to the end of the exhaust crankshaft 12 closest to the gear 464, which places the gear 464 between the flex plate 571 and the cranks of the exhaust crankshaft 14. Coupling the drive transmission 570 to a crankshaft potentially increases the engine's efficiency. This is because when the drive transmission 570 is connected to one of the crankshafts directly, then only torque from the other crankshaft is transmitted through the gear train. In gear trains where the drive transmission (e.g., drive power take-off) is connected to an idler gear, torque from both of the crankshafts is transmitted through the gear train to the transmission. The reduction in the amount of torque transmitted through the gear train means that the gears in the gear train 455 shown in FIGS. 4, 5A, and 5B, where the drive transmission 570 is connected to the exhaust crankshaft 12, may be thinner than the gears of the prior art gear train 55 shown in FIGS. 2 and 3, in which the transmission connects to the gear train at an idler gear or an idler gear post.

In some implementations, changing the location of the connection to the drive transmission from an idler gear in the middle of the gear train to the exhaust crankshaft or exhaust crankshaft gear can result in a reduction of about 50% in the torque transmitted through the gear train.

With reference to FIG. 5A, the relative positions of the crankshafts 12 and 14 and the gear train 455 are defined with respect to an axis 600. For example, the axis 600 may be the longitudinal axis of a cylinder (not shown) that contains the pair of opposing pistons nearest the gear train 455. The rotational axes 606 and 607 of the crankshafts 12 and 14 are disposed in a spaced-apart, parallel relationship, with each crankshaft axis 606, 607 orthogonally intersecting the longitudinal axis 600. Preferably, the spaced-apart, parallel relationship is vertical, with the crankshaft 12 being located below the crankshaft 14.

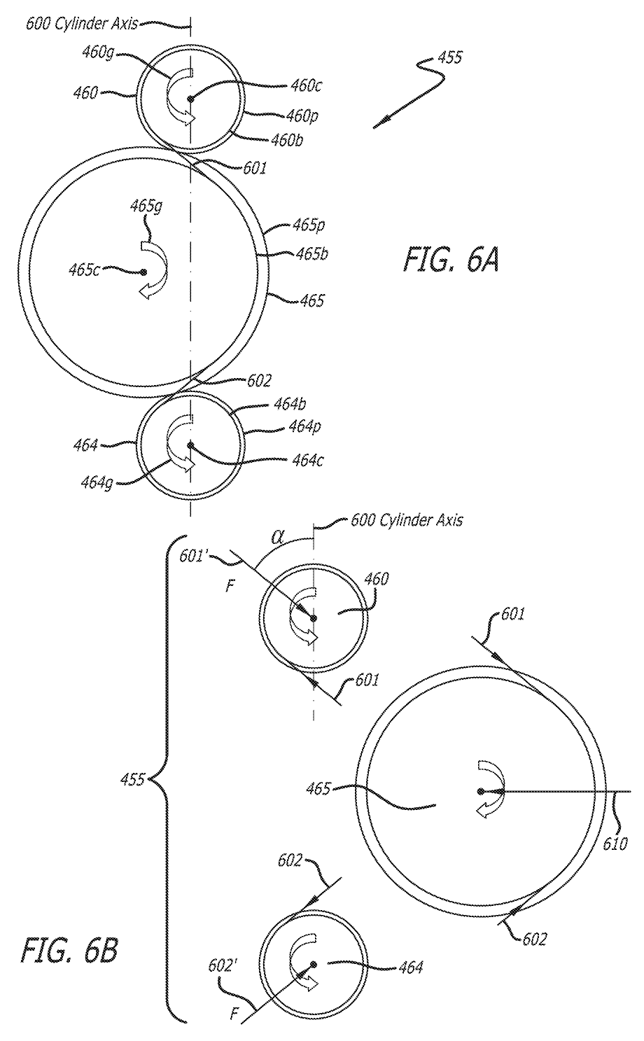

FIG. 6A shows an exemplary arrangement of the gear system 455, in which the relative positions of the intake crankshaft gear 460, the exhaust crankshaft gear 464, and the idler gear 465 are defined with respect to the longitudinal cylinder axis 600. For the intake crankshaft gear 460, FIG. 6A also shows the center of the gear, 460c, the direction of rotation of the gear 460g, the pitch circle 460p of the gear, and the base circle 460b of the gear. Similarly, the directions of rotation for the idler gear and exhaust crank gear are shown, 465g and 464g, respectively, as well as the gear centers, 465c and 464c, pitch circles 465p and 464p and the base circles 465b and 464b, respectively. For each mesh, or point of interaction between two adjacent gears, there is a line of action indicated. The mesh between the intake crankshaft gear 460 and the idler gear 465 is indicated by the line of action 601. This line of action 601 has end points on the base circles 460b and 465b and crosses the point where the pitch circles 460p and 465p touch. A line of action 602 between the idler gear 465 and the exhaust crankshaft gear 464 is also shown. The line of action 602 crosses the point where the pitch circles 465p and 464p touch.

FIG. 6B shows the forces acting in the three-gear system 455 of the gear train. Assumed in this three-gear system 455 is that the crank to crank center distance is 564.7 mm. In addition to the gears 460, 464, and 465 shown in FIG. 6A with their direction of rotation and the cylinder axis 600, the lines of action 601 and 602, vectors showing the directions 601′ and 602′ of forces acting on the gears F, as well as the angle α between the vectors 601″ and 602 and the cylinder axis 600 are also shown in FIG. 6B.

When the forces F act along the cylinder axis 600, then a equals 0°. The side load on the crankshafts imposed by the forces acting in the gear system 455 (i.e. gear train) can be calculated as the product of the forces acting on each gear F with the sine of the angle between the direction of the force and the cylinder axis, α. In other words,

side load on the crank=F·sin α (eq. 1).

The side load can be calculated for each crankshaft in a given gear train design. The loads 610 on the post attached to the idler gear (i.e., the idler post) can also be calculated based upon the forces on the crankshafts and the angle α for each force. When designing a gear train for an opposed-piston engine, the side loads on the intake and exhaust crankshafts, as well as on the idler post, can be minimized by selecting appropriate locations of the three gears to manipulate α. Further, minimizing the magnitude of the angle α is a factor in ensuring that the main bearing caps and bolts (24 and 26 in FIG. 1) are loaded in the appropriate direction, preventing premature failure of the engine due to forces on the main bearing caps and bolts during operation.

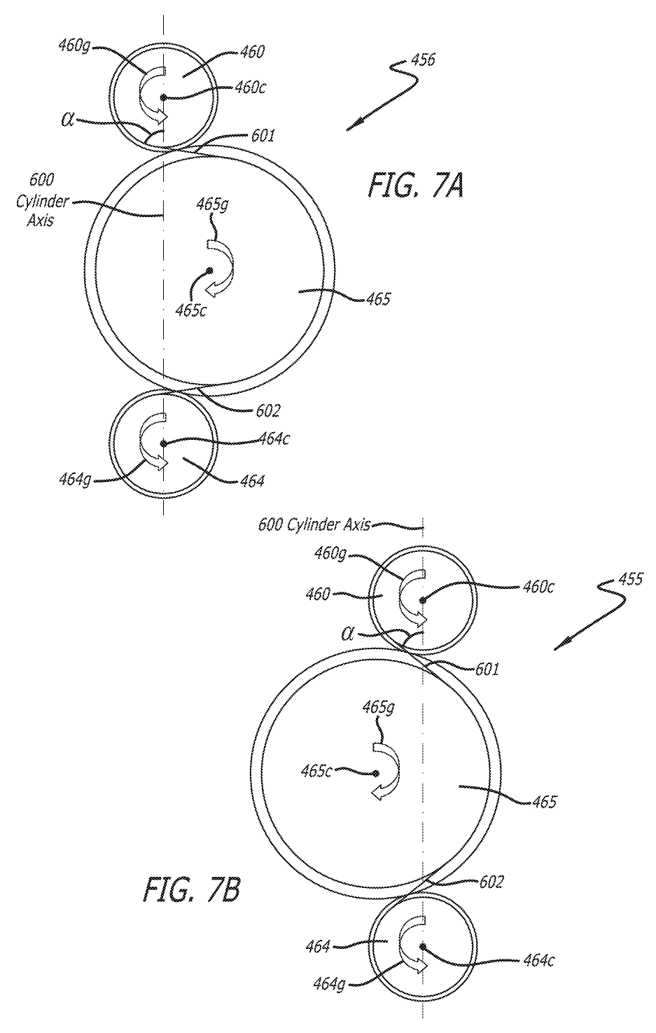

FIG. 7A shows a configuration for a three-gear system 456 of a gear train for an opposed-piston engine. In this system 456, there is an intake crankshaft gear 460 with its rotation direction 460g and gear center 460c shown and the angle α between the cylinder axis 600 and the action line 601 which shows the location of interaction between the intake crankshaft gear 460 and the idler gear 465. FIG. 7A also shows an exhaust crankshaft gear 464 with its gear center 464c and direction of rotation 464g, along with the line of action 602 between the exhaust gear 464 and the idler gear 465. In the gear system 456, the center of the intake crankshaft gear 460c and the center of the exhaust crankshaft gear 464c are aligned with the cylinder axis 600. The center 465c of the idler gear 465 is not aligned with the cylinder axis 600: instead, the center 465c of the idler gear 465 is offset from the cylinder axis 600 such that the angle α is large. The center of each gear (e.g., 460c, 464c, 465c) is the area approximately at and surrounding the axis of the rotation of each gear. In some implementations, the gears are mounted on a post or shaft at their centers. The intake crankshaft gear 460 is attached to the intake crankshaft at its center 460c; the exhaust crankshaft gear 464 is attached to the exhaust crankshaft at its center 464c; the idler gear 465 is attached to a post at its center 465c. As can be seen from equation 1, a large α means a large side load on the crank for a given gear. Examples of a large α include values greater than 45°, greater than 50°, greater than 60°, greater than 70°, and approximately 90′.

FIG. 7B shows a configuration for a three-gear system 455 with the same components, including an intake crankshaft gear 460, an idler gear 465, and an exhaust crankshaft gear 464, but aligned differently. The intake crankshaft gear 460 and the exhaust crankshaft gear 464 are centered along the cylinder axis 600, while the idler gear 465 is aligned so that its center 465c is not along the cylinder axis 600 and a for both of the crankshaft gears is smaller than that in FIG. 7A. Examples of a small a include values of 45° or less, such as 40° or less, 35° or less, 30° or less, including values ranging from 0° to 90°, values from 35° to 45°, values from 0° to 45°, and approximately 0°. The angle α can be selected to accommodate the engine packaging constraints. The attachment point for the drive transmission can also be selected to accommodate the engine packaging constraints while optimizing gear system to minimize the gear system friction.

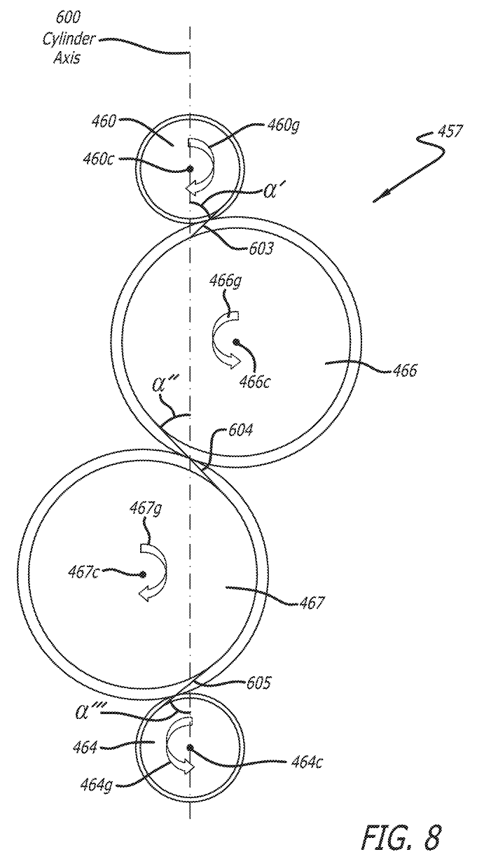

FIG. 8 shows another configuration for a gear train 457 for use with an opposed-piston engine. The gear train 457 has four gears: a gear connected to the intake crankshaft 460, a gear connected to the exhaust crankshaft 464, a first idler gear 466, and a second idler gear 467. Each gear is shown with its center 460c, 464c, 466c, 467c and direction of rotation 460g, 464g, 466g, 467g. The gear train 457 shown in FIG. 8 differs from those shown in FIGS. 4-7B in that the gear train 457 has four gears, three gear meshes, and the gears attached to the intake and exhaust crankshafts are rotating in different directions. For each gear mesh shown in FIG. 8, there is a line of action shown 603, 604, 605. The line of action 603 between the gear on the intake crankshaft 460 and the first idler gear 466 indicates force acting along the line 603 a first number of degrees α′ away from the cylinder axis 600. Similarly, the line of action 604 between the first idler gear 466 and the second idler gear 467 indicates a force acting along the line 604 a second number of degrees α″ away from the cylinder axis 600, and the line 605 indicates force acting α′″ degrees away from the cylinder axis 600 between the second idler gear 467 and the gear 464 attached to the exhaust crankshaft.

As can be seen in FIG. 8, the gears attached to crankshafts 460, 464 are aligned with their centers 460c, 464c along the cylinder axis 600. The idler gears 466, 467 can be positioned so that α′ and α′″ are opposite in direction and equal in magnitude, so that forces acting along the corresponding action lines 603, 605, respectively, effectively cancel each other out, leaving only the forces acting along action line 604 between the two idler gears 466, 467 to exert force on the idler gears and their posts. In some implementations, α″ can be selected to minimize the resultant forces on the idler gear posts, such that the forces approach or are effectively zero, thus reducing friction in the gear train. The gear train shown in FIG. 8 assumes connection of the drive transmission to one of the gears attached to a crankshaft 460, 464, as well as a crank to crank center distance of 564.7 mm.

Those skilled in the art will appreciate that the specific embodiments set forth in this specification are merely illustrative and that various modifications are possible and may be made thereto without departing from the scope of the following claims.

1. An opposed-piston engine having a first crankshaft, a second crankshaft, and a plurality of cylinders arranged between the first and second crankshafts, in which the first and second crankshafts are disposed in a parallel, spaced-apart relation, and a gear system coupling the first and second crankshafts consists of three gears; such that:
a first gear of the three gears is connected to the first crankshaft;
a second gear of the three gears is connected to the second crankshaft; and
a third gear of the three gears comprising an idler gear is positioned between the first and second gears, the third gear being configured to transmit torque from the first gear to the second gear through a first gear mesh with the first gear and a second gear mesh with the second gear; wherein:
a center of the first gear is aligned with a longitudinal cylinder axis of the opposed-piston engine;
a center of the second gear is aligned with the center of the first gear along the longitudinal cylinder axis of the opposed-piston engine;
the third gear is not aligned with the longitudinal cylinder axis of the opposed-piston engine; and,
an angle α between the longitudinal cylinder axis and a line of action that passes through the first gear mesh is greater than or equal to 0° and less than 90°.

2. The opposed piston engine of claim 1, wherein the first crankshaft is an intake crankshaft which is connected to one or more intake pistons in the opposed-piston engine whose motions open and close one or more intake ports; and the second crankshaft is an exhaust crankshaft which is connected to one or more exhaust pistons in the opposed-piston engine whose motions open and close one or more exhaust ports.

3. The opposed piston engine of claim 2, wherein a transmission to provide driving power is operably connected to the exhaust crankshaft.

4. The opposed piston engine of claim 3, wherein auxiliary systems are operably connected to the intake crankshaft.

5. The opposed piston engine of claim 4, wherein the auxiliary systems comprise one or more of a pump, a supercharger, and a compressor.

6. The opposed piston engine of claim 1, wherein the gear train is configured to maintain a timing of relative motion between intake and exhaust pistons in the opposed-piston engine.

7. The opposed piston engine of claim 2, wherein the gear train is configured to maintain a timing of relative motion between intake and exhaust pistons in the opposed-piston engine.

8. The opposed piston engine of claim 3, wherein the gear train is configured to maintain a timing of relative motion between intake and exhaust pistons in the opposed-piston engine.

9. The opposed piston engine of claim 4, wherein the gear train is configured to maintain a timing of relative motion between intake and exhaust pistons in the opposed-piston engine.

10. The opposed piston engine of claim 5, wherein the gear train is configured to maintain a timing of relative motion between intake and exhaust pistons in the opposed-piston engine.

11. A gear system for coupling a first crankshaft with a second crankshaft, in which the first and second crankshafts are disposed in a parallel, spaced-apart relationship, the gear system comprising a gear train with:
a first gear attached to the first crankshaft;
a second gear attached to the second crankshaft; and
a third gear comprising an idler gear between the first and second gear that is contiguous with the first and second gears so as to transmit torque from the first gear to the second gear through a first gear mesh with the first gear and a second gear mesh with the second gear; wherein:
a center of the first gear is aligned with a longitudinal axis that orthogonally intersects an axis of the first crankshaft and an axis of the second crankshaft;
a center of the second gear is aligned with the center of the first gear along the longitudinal axis;
the third gear is not aligned with the longitudinal axis; and,
an angle α between the longitudinal axis and a line of action that passes through the first gear mesh is greater than or equal to 0° and less than 90°.

12. The gear system of claim 11, wherein the parallel, spaced-apart relationship is a substantially vertical relationship in which the first crankshaft is disposed above the second crankshaft.

13. The gear system of claim 12, wherein the second crankshaft is coupled to a transmission.

14. The gear system of claim 13, wherein auxiliary systems comprising one or more of a pump, a supercharger, and a compressor are operably connected to the first crankshaft.

15. The gear system of claim 11, wherein auxiliary systems comprising one or more of a pump, a supercharger, and a compressor are operably connected to the first crankshaft.

16. The gear system of claim 11, wherein the gear train is configured to maintain a timing of relative motion between the first and second crankshafts.

17. The gear system of claim 12, wherein the gear train is configured to maintain a timing of relative motion between the first and second crankshafts.

18. The gear system of claim 13, wherein the gear train is configured to maintain a timing of relative motion between the first and second crankshafts.

19. The gear system of claim 14, wherein the gear train is configured to maintain a timing of relative motion between the first and second crankshafts.

20. The gear system of claim 15, wherein the gear train is configured to maintain a timing of relative motion between the first and second crankshafts.

21. A gear system for coupling a first crankshaft with a second crankshaft, in which the first and second crankshafts are disposed in a parallel, spaced-apart relationship, the gear system comprising a gear train with:
a first gear attached to the first crankshaft;
a second gear attached to the second crankshaft; and
a third gear and a fourth gear, each of the third and fourth gear comprising an idler gear attached to an idler gear post, in which:
the third gear is between the first and fourth gear;
the fourth gear is between the third and second gear; and
the gear train transmits torque from the first gear to the second gear through a first gear mesh between the first gear and third gear, a second gear mesh between the third and fourth gear, and a third gear mesh between the fourth gear and second gear; wherein:
a center of the first gear is aligned with a longitudinal axis that orthogonally intersects an axis of the first crankshaft and an axis of the second crankshaft;
a center of the second gear is aligned with the center of the first gear along the longitudinal axis;
the third gear and fourth gear are not aligned with the longitudinal axis; and,
a first number of degrees α′ between the longitudinal axis and a line of action that passes through the first gear mesh, a second number of degrees α″ between the longitudinal axis and a line of action that passes through the second gear mesh, and a third number of degrees α′″ between the longitudinal axis and a line of action that passes through the third gear mesh, in which the first number of degrees α′ and the third number of degrees α′″ are opposite in direction and equal in magnitude.

22. The gear system of claim 21, wherein the second number of degrees α″ is selected to minimize the resultant forces on the third gear's idler gear post and the fourth gear's idler gear post.

23. The gear system of claim 22, wherein the second number of degrees α″ is selected so that the resultant forces on the third gear's idler gear post and the fourth gear's idler gear post approaches zero and reduces friction in the gear train.

24. An opposed-piston engine comprising the gear system of claim 21 further comprising a drive transmission operably connected to either the first gear or the second gear of the gear train.
